(19) United States
(12) Patent Application Publication
(10) Pub. No.: US 2026/0203680 A1
(43) Pub. Date: Jul. 16, 2026

(54) Systems and Methods for a Bidirectional Cooperative E-Commerce and Logistics Platform

(71) Applicant: WALEED S NEMA, Garland, TX (US)

(72) Inventor: WALEED S NEMA, Garland, TX (US)

(21) Appl. No.: 19/355,196

(22) Filed: Oct. 10, 2025

Related U.S. Application Data
(60) Provisional application No. 63/881,279, filed on Sep. 13, 2025.

(51) Int. Cl. G06Q 10/0631; G06Q 10/083

(52) U.S. Cl. CPC G06Q 10/06311; G06Q 10/0843

(57) ABSTRACT

Disclosed is a cooperative, computer-implemented framework, herein referred to as the e-Sellers Platform (eSP), that operates as a non-custodial marketplace to coordinate independent sellers, buyers, and logistics providers. The framework solves key problems in the e-commerce ecosystem, namely monopolies, inefficient returns, and carrier redundancies. The invention's architecture functionally decouples middle-mile transit (“xHood”) from local first-mile and last-mile (“hood”) operations. This decoupling is a key enabler, allowing for the creation of a symmetrical, bidirectional logistics network that re-configures and optimizes existing logistics assets, including the underutilized vehicle capacity of e-commerce platforms. Local operations are managed by a novel, fairness-based assignment algorithm that equitably assigns tasks to a cooperative fleet of any size. The resulting system scales the logistics infrastructure, reduces environmental and financial waste, and creates a more efficient and equitable marketplace for all stakeholders.

### CROSS-REFERENCE TO RELATED APPLICATIONS

This application claims the benefit of the provisional application No. 63/881,279 with a filing 371 (c) date of Sep. 13, 2025 under the title “Systems and Methods for a Bidirectional Cooperative E-Commerce and Logistics Platform”.

### FEDERALLY SPONSORED RESEARCH AND DEVELOPMENT

Not Applicable.

### REFERENCE TO A “SEQUENCE LISTING”, A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not Applicable.

### REFERENCES CITED

| Patent Number | Title |
|---|---|
| U.S. Pat. No. | Containers for crowdsourced delivery |
| 10,657,486 B1 | |
| U.S. Pat. No. | System and method for generating a |
| 11,574,277 B2 | delivery plan for multi-tier |
| | delivery schemes |
| U.S. Pat. No. | Systems and methods of gig-economy |
| 11,928,738B1 | fleet mobilization |
| US 2008/0177617 A1 | Content production/sharing platform |
| U.S. Pat. No. | Reverse logistics process |
| 7,596,516 B2 | |
| U.S. Pat. No. | Dynamic vehicle routing for |
| 9,569,745 B1 | regional clusters |

### BACKGROUND

### Field

This disclosure relates to systems and methods relevant to e-commerce and logistics administrative, digital, and financial management (e.g. CPC classifications G06Q 10, 30, 40 & 50) in addition to Machine learning (G06N20). Particularly, it relates to cooperative and complementary approaches to solving problems.

### Problem Statement

### P1—Monopolies:

E-commerce has become a mainstream and growing method for buying and selling. This has resulted in increased competition in favor of larger companies with more resources and the ability to keep smaller players out of the game. Logistical challenges of shipping products and returns further reinforce the same argument. The end result are monopolies that keep smaller businesses out of the loop with diminishing opportunities and greater challenges. The current anti-trust lawsuit by the Department of Justice against Amazon is a case in point alleging “monopoly, anti-competitive practices”, “arm-twisting and harm to vendors”, etc.

### P2—Returns:

E-commerce returns are bad for the environment and cost the economy billions of dollars every year in addition to inflating vendor costs and product pricing. Since the cost of returns is indirectly built in the selling price, people who do not return are disadvantaged. Returns also encourage overspending and lead to unnecessary credit card fee surcharges.

### P3—Carrier Redundancies:

Multiple delivery trucks belonging to different carriers but covering the same geographic area duplicate effort, waste resources, and hurt the environment.

Other challenges include door-step delivery issues related to security, safety, deliveries requiring temperature control, weather conditions, animals, etc.

### Prior Art

The disclosed invention presents a comprehensive, multi-faceted system that re-engineers e-commerce and logistics through a cooperative, technology-driven framework. Given the vast scope, which touches upon multi-tier logistics, crowdsourcing, vehicle routing algorithms, e-commerce business methods, and cooperative platforms, a robust analysis of the prior art is essential. The patent landscape in these individual areas is crowded. Therefore, the patentability of the present invention will not rely on any single component in isolation, but on the synergistic combination of these components, the novel architectural decisions that enable this synergy, and the specific, technically detailed algorithms and methods that are not taught or suggested by the prior art.

This review will address the most relevant prior art in several key areas, outlining the expected challenges and providing a strategic basis for distinguishing the present invention.

### 1. Multi-Tier Logistics and the “Hood/xHood” Architecture

The functional decoupling of the local “hood” layer from the middle-mile “xHood” layer is a foundational architectural choice of the invention. This structure will likely be challenged as an obvious implementation of multi-tier or multi-echelon logistics.
Anticipated Challenge: An examiner will likely cite patents describing multi-echelon or multi-tier delivery schemes. A key piece of prior art in this area is U.S. Pat. No. 11,574,277, which explicitly describes a system for generating delivery plans where a primary vehicle conveys shipments to a hub, after which an “agent tier” handles the final segment of the delivery route. This patent teaches the general concept of a two-tier structure for last-mile delivery.
Distinguishing Argument and Novelty: The novelty of the present invention lies not in the mere existence of two tiers, but in the argument that the strict functional decoupling of the “hood” and “xHood” layers is a specific, non-obvious design choice that serves as an enabler for a cascade of novel functionalities not contemplated by the prior art.
First-Mile Symmetry: The most powerful distinguishing feature is the application of the “hood” model to create a symmetrical, bidirectional logistics framework, as illustrated in FIG. 1. The prior art, including U.S. Pat. No. 11,574,277, is overwhelmingly focused on optimizing the last mile (distribution). The present invention applies the standardized “hood” concept to the first mile, enabling a cooperative vehicle to perform consolidated pickups from multiple, disparate, and even competing sources (e.g., a local business, a FedEx DC, and an at-home return) in a single run. This unconventional application to solve carrier redundancy at the point of origin is a direct result of the enabling architecture.
Enabling a Truly Cooperative Fleet: The decoupling creates a standardized interface to the local “hood” layer. This interface is the technical key that allows for the management of a heterogeneous, multi-entity cooperative fleet (HNs and HFs) via a single, centralized algorithm, a concept not taught by the hierarchical, single-carrier models described in the prior art.

### 2. Cooperative Vehicle Routing and the “Fair Fill Fleet” Algorithm

The field of vehicle routing problems (VRP) is mature, with extensive literature on multi-depot VRP (MDVRP), VRP with pickup and delivery (VRPPD), and collaborative multi-carrier VRP (CMCVRP).
Anticipated Challenge: An examiner may cite patents such as U.S. Pat. No. 9,569,745 B1, which describes a system for dynamically adding new pickup orders by clustering vendors by geographic region and then running optimization techniques to select the most desirable route based on efficiency metrics like cost and travel distance. Further, academic literature on CMCVRP discusses collaboration between carriers to reduce costs, often through auctions or cost-sharing models based on Shapley values.
Distinguishing Argument and Novelty: This invention is distinguished by the specific, multi-layered logic of the Fair Fill Fleet (FFF) algorithm, which is not taught by the prior art.
Novel Objective Function: Unlike the prior art, which overwhelmingly optimizes for efficiency (cost, speed, distance), the FFF algorithm's primary objective is fairness. This is a non-obvious choice for a logistics algorithm.
Specific Fairness-Based Vehicle Selection: The novelty is in the specific, computer-implemented method for achieving this fairness, as detailed in FIG. 10 and the pseudo-code of FIG. 13. The method of alternating selection between distinct classes of vehicles (individual HNs vs. multi-vehicle HFs) and further alternating between competing carrier groups within the HF class is a specific, non-obvious algorithm not found in the prior art.
Specific Prioritized Package Allocation: The package allocation module, detailed in FIG. 12 and Table 1, describes a novel, prioritized sequence of heuristic strategies (e.g., EXACT SINGLE, EXACT SUM, NEXT LARGER). This is a specific, non-obvious method for optimizing vehicle fill while minimizing fragmentation, a level of technical detail that goes far beyond the general “optimization techniques” mentioned in prior art like U.S. Pat. No. 9,569,745 B1.

### 3. Crowdsourced Delivery and Secure Agent Pickup

The use of crowdsourced or gig-economy drivers for delivery is a well-established concept.
Anticipated Challenge: Patents such as U.S. Pat. No. 10,657,486 B1 (assigned to DoorDash) describe systems that enable people to participate as couriers in a crowdsourced network.
U.S. Pat. No. 11,928,738 describes systems for mobilizing gig-economy fleets, including generating alerts for high-demand situations.
Distinguishing Argument and Novelty: The invention is distinguished by its focus on a trusted, community-based network and the specific security protocol that enables it.
   Trusted Personal Network: The “Hood Neighbor” concept is explicitly expanded beyond gig workers to include a buyer's personal network (family, friends). The system provides a specific user interface and method for a buyer to manage a roster of these trusted agents, as shown in FIG. 16.
   Novel Security Protocol: The prior art does not teach the specific, three-party, two-factor authentication method for physical package pickup detailed in FIG. 17. The process—where the system sends a time-sensitive code to the Buyer, who must then relay it in real-time to the Agent for verification at the Hood Center—is a novel and non-obvious solution to the problem of secure, authenticated hand-offs in a cooperative, non-employee network.

### 4. E-Commerce Business Methods and Reverse Logistics

The patentability of business methods is well-established, provided they are tied to a specific technical implementation and produce a “useful, concrete, and tangible result”.
Anticipated Challenge: The field of reverse logistics is active, with patents like U.S. Pat. No. 7,596,516 B2 describing methods for optimizing the return of goods. Services like Veho and ReturnQueen also offer at—home, label-free return pickups.
Distinguishing Argument and Novelty:
   Returns Surcharge and Auto-Refund: The prior art on returns focuses on logistical efficiency or policy clarity. The method detailed in FIG. 4 (step 4020) is a novel, computer-implemented financial instrument embedded directly into the checkout process. The combination of a visible surcharge with an automatic, time-based refund is a non-obvious method for solving the returns problem (P2) by creating a new financial and psychological incentive structure for the consumer.
   Integrated Reverse Logistics: While at—home pickup services exist, the present invention's method is novel due to its deep integration into the Symmetrical Bidirectional Logistics Framework (FIG. 1). An at-home return (3012) is not a separate service but is treated as a standard first-mile task, ingested into the same queues and managed by the same cooperative fleet and FFF algorithm as forward-logistics pickups. This systemic integration is a key differentiator.

### 5. Cooperative and Open-Source Platform Governance

Anticipated Challenge: The concepts of cooperative business models, open-source software, and profit-sharing are known in business and law. Patents like US 2008/0177617 A1 describe revenue sharing for content platforms.
Distinguishing Argument and Novelty: The invention's novelty lies in the specific, computer-implemented system that technically enforces the cooperative model.
   Defensive Patent and Open-Source Method: The combination of seeking patent protection for the core methods while making the platform software open-source is a specific and non-obvious strategy to ensure transparency and prevent monopolistic capture, as described in the specification.
   Automated, Multi-Stakeholder Financial Reconciliation: The system includes a specific financial reconciliation module that programmatically tracks the platform's net balance and executes a novel distribution algorithm. This algorithm distributes a surplus among multiple, distinct classes of stakeholders (Sellers, HCs, HFs, HNs) based on their electronically tracked participation metrics. This is a specific, non-obvious business method that is not taught by general profit-sharing patents, which typically describe simpler commission-based models.

By proactively addressing these areas, the application can demonstrate that while it builds upon known concepts, its unique architecture and the specific, detailed methods it enables constitute a significant and patentable advance over the prior art.

### SUMMARY OF THE INVENTION

The P1—Monopoly, P2—Returns, and P3—Carrier Redundancy problems stated earlier are solved by the systems and methods of the present disclosure, which disrupt conventional e-commerce and logistics models by introducing a transparent, cooperative, and technologically unified framework. This framework is managed by a central computer system, the e-Sellers Platform (eSP), which coordinates a plurality of independent sellers, buyers, and logistics providers. The core of the invention is an architectural design that functionally decouples middle-mile transit (“xHood”) from local first-mile and last-mile (“hood”) operations, a separation that enables the novel solutions described herein.

This enabling architecture allows for a Symmetrical Bidirectional Logistics Framework, as illustrated in FIG. 1. Unlike conventional models focused on the last mile, the present invention applies a cooperative “hood” model to the first mile, performing consolidated pickups from a plurality of disparate and even competing sources, including local businesses (3014), carrier distribution centers (3018), and at-home product returns (3012). This symmetrical application directly mitigates carrier redundancy (P3) at both the point of origin and the point of delivery. This cooperative local fleet, comprising both individual Hood Neighbors (HN) and multi-vehicle Hood Fleets (HF), is managed by a novel, computer-implemented Fair Fill Fleet (FFF) algorithm, the logic of which is detailed in nine FIGS. 7-15. This algorithm is uniquely configured with fairness as a primary objective, equitably distributing logistics tasks among all participants to solve the monopoly problem (P1) in the local logistics space.

The technical framework is designed to support a novel cooperative governance and financial model that provides the ultimate incentive for cooperation. The eSP software is implemented within an open-source framework, a core functional aspect that ensures transparency and allows all participants to inspect the system's logic, including the fairness rules of the FFF algorithm. Furthermore, the invention includes a computer-implemented Cost/Profit Sharing Plan, wherein the eSP's financial reconciliation module programmatically tracks the system's net operational balance. In the event of a surplus, a distribution algorithm automatically allocates a share among all key stakeholder classes-including sellers, logistics hubs, and vehicle operators-based on their electronically tracked participation and performance metrics. This transforms logistical partners into financial stakeholders, ensuring the long-term viability and cooperative integrity of the ecosystem.

The Returns problem (P2) is solved through a two-pronged approach enabled by the framework. Logistically, at-home returns (3012) are seamlessly and efficiently integrated into the symmetrical first-mile pickup flow. Financially, the e-commerce checkout process is modified, as shown in FIG. 4, to include a visible Returns Surcharge (4520) with the explicit promise of an automatic, time-based refund if the item is not returned, creating a transparent and fair model for all customers.

Central to this entire framework is the concept of the Hood Center (HC) (3016), which can be any local business. The HC functions as a bidirectional hub for first-mile consolidation and last-mile distribution, providing the physical infrastructure that makes the distributed and open business model of this disclosure possible, thereby creating a scalable and equitable alternative to current monolithic business models.

### DESCRIPTION

### Definitions

| Term | Definition |
|---|---|
| Active Seller | A seller entity registered with the eSP that has elected to participate |
| | in the cooperative Cost/Profit Sharing Plan. |
| Always-Free- | A business rule implemented by the eSP wherein the cost of the |
| to-DC | middle-mile (“xHood”) shipping segment is not charged to the buyer, |
| | but is programmatically allocated to the seller. |
| Always-Priority | An operational paradigm implemented by the eSP wherein all orders |
| | are treated with a single, high-priority status, and wherein the |
| | system's primary objective is to minimize the total time from payment |
| | confirmation to final delivery. |
| Buyer | An individual or entity that purchases products or services via an e- |
| | commerce platform. |
| Carrier | A commercial logistics operator, such as FedEx or UPS, that may |
| | participate in the cooperative network as a Hood Fleet (HF) and/or as |
| | an xHood carrier. |
| Casual Seller | A seller entity registered with the eSP that has not elected to |
| | participate in the cooperative Cost/Profit Sharing Plan and is subject |
| | to a standard transaction fee model. |
| Chain Store | Any business with multiple physical locations, such as hypermarkets, |
| | department stores, or franchises, which may act as a Hood Center or |
| | provide a Virtual Logistics Bridge. |
| Cluster | A geographic grouping of multiple, distinct final delivery addresses for |
| | individual packages, used by the FFF algorithm for optimizing hood |
| | delivery routes. |
| Cooperative | The collective set of all vehicles available for dispatch within a “hood,” |
| Fleet | comprising both Hood Fleet (HF) and Hood Neighbor (HN) vehicles. |
| Cost/Profit | A computer-implemented financial method of the eSP that |
| Sharing Plan | programmatically allocates operational deficits or distributes |
| | operational surpluses among designated stakeholders (e.g. Active |
| | Sellers, HCs, HFs, HNs) based on tracked participation metrics. |
| Distribution | A physical facility that serves as an interface between the “xHood” |
| Center (DC) | and “hood” logistics layers (used for first-mile consolidation and last- |
| | mile distribution). |
| e-Commerce | A conventional e-commerce platform, such as Amazon or Etsy, which |
| Platform (eCP) | may be integrated with the eSP. |
| e-Sellers | The central computer system of the present disclosure that manages |
| Platform (eSP) | the non-custodial marketplace and coordinates the cooperative |
| | logistics network. |
| Fair Fill Fleet | A computer-implemented method of the eSP for assigning logistics |
| (FFF) | tasks to a cooperative fleet, comprising a fairness-based vehicle |
| Algorithm | selection module and a prioritized package allocation module. |
| Hood | A defined geographic area, such as a neighborhood, representing the |
| | operational domain for first-mile, last-mile, or intra-hood logistics. |
| Hood Center | A local business or a standalone automated POD that is registered |
| (HC) | with the eSP to act as a physical hub for package consolidation, |
| | pickup, and drop-off within a hood. |
| Hood Fleet | A participating carrier entity that operates one or more vehicles within |
| (HF) | the cooperative “hood” network. |
| Hood Neighbor | A participating individual or small-scale entity, including a buyer's |
| (HN) | designated agent, that operates a single vehicle within the |
| | cooperative “hood” network. |
| Intra-Hood | An operational mode for the cooperative fleet, depicted in FIG. 1, for |
| Zone | transporting packages between two points within the same hood, |
| | such as between two different carrier DCs, bypassing the “xHood” |
| | layer. |
| isReady flag | A real-time data status associated with each vehicle in the |
| | cooperative fleet, indicating its availability for dispatch (e.g., ‘on’, ‘off’, |
| | ‘onBreak’, ‘urgent’), which is monitored by the JITAIL system as |
| | shown in FIG. 11. |
| JITAIL | “Just-in-Time Al Logistics”; a method of the eSP for dynamically |
| | recalculating logistics plans in real-time in response to disruption |
| | events, using Al to improve predictive estimates over time. |
| Symmetrical | The architectural framework of the invention, shown in FIG. 1, |
| Bidirectional | wherein the cooperative “hood” model is applied to both first-mile |
| Logistics | pickups (Source Hood) and last-mile deliveries (Destination Hood). |
| Virtual | A method of using the internal, pre-existing logistics network of a |
| Logistics | partner retail entity as a carrier for the “xHood” middle-mile transit of |
| Bridge | third-party packages, as shown in FIG. 2. |
| xHood | The middle-mile or long-haul transit segment of the logistics network, |
| | connecting source and destination hubs (DCs or HCs). |

### BRIEF DESCRIPTION OF THE DRAWINGS

FIG. 1 is a diagram illustrating the Symmetrical Bidirectional Logistics Framework of the present invention.

FIG. 2 is a flowchart illustrating the process of the Virtual Logistics Bridge.

FIG. 3 is a sequence diagram showing a high-level overview of the system and its main actors.

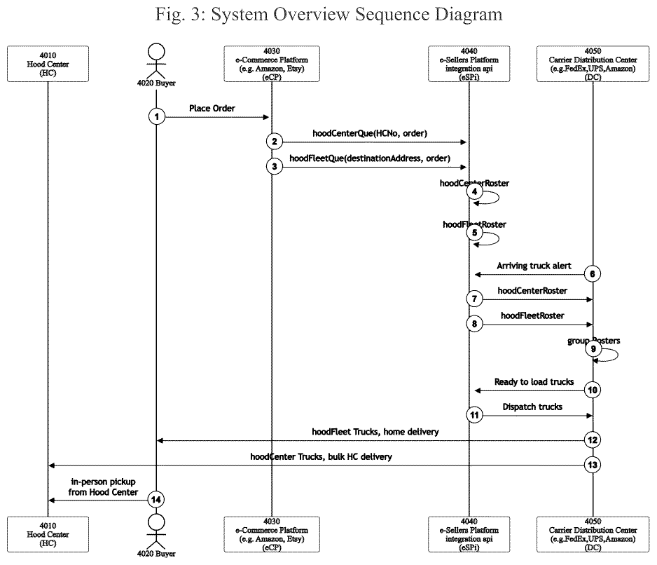

FIG. 4 is a flowchart illustrating the novel steps in placing an order on an e-Commerce Platform integrated with the system.

FIG. 5 is a flowchart illustrating the logic for determining order status for Hood Center pickup or home delivery.

FIG. 6 is a diagram illustrating the process of finding the nearest Hood Centers and their associated fleet resources.

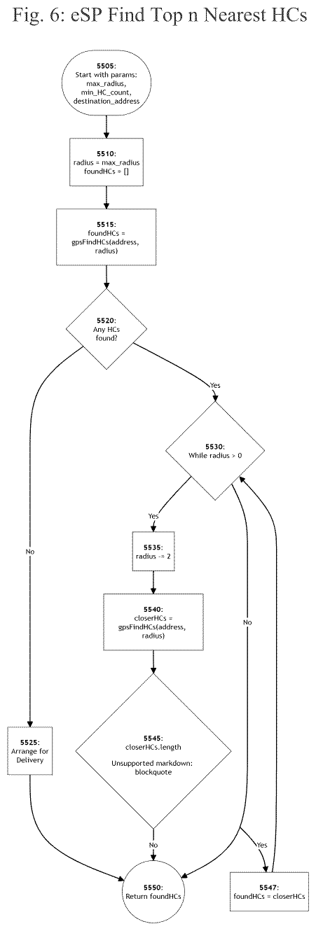

FIG. 7 is a diagram showing a high-level view of the Fair Fill Fleet package scheduling process.

FIG. 8 is a flowchart illustrating the main loop of the Fair Fill Fleet algorithm.

FIG. 9 is a diagram illustrating the fairness rule for assignment planning in the destination hood.

FIG. 10 is a flowchart illustrating the high-level logic for the HN/HF round-robin vehicle selection method.

FIG. 11 is a flowchart illustrating the process for determining real-time vehicle readiness.

FIG. 12 is a diagram illustrating the precedence of methods for vehicle capacity matching.

FIG. 13 is a representation of pseudo-code for the main Fill Fleet algorithm.

FIG. 14 is a representation of pseudo-code for the planAssignmentsForVehicle sub-process.

FIG. 15 is a representation of pseudo-code for the findPlanForCellSet sub-process.

FIG. 16 is a flowchart illustrating the process for a buyer to authorize an agent for package pickup.

FIG. 17 is a flowchart illustrating the secure protocol for an agent picking up a package at a Hood Center.

FIGS. 18A-18C are diagrams illustrating an embodiment of an Automated and Modular Hood Center (POD), wherein FIG. 18A shows an external view, FIG. 18B shows an internal cutaway view, and FIG. 18C shows a modular expansion view.

### CONCRETE EXAMPLE

This example covers a source hood scenario with packages at 2 HCs destined to 5 different DCs; and, a destination hood scenario with fresh packages arriving at 2 DCs that need to loaded into HFs/HNs and dropped off in bulk at 3 HCs, and other individual home delivery packages that have been clustered into cluster CL1 and CL2.

Table 2 shows the list of filtered source hood vehicles and Table 3 shows the list of filtered destination hood vehicles which are sorted within HF and within HN on a first-come-first-serve basis. HFs and HNs must be registered with HCs and DCs beforehand, which is the first filtering criteria. Other filtering factors are related to vehicle properties related to special equipment, package size, weight, etc. Factors related to the owning business include operating hours and the all important is Ready flag, which can be set to either ‘on’, ‘off’, or ‘urgent’. This flag is watched in real-time and triggers immediate FFF recalculation and remediation action when the status is set to ‘urgent’ in case of a vehicle breakdown or accident while carrying packages.

Notice that Table 3 has one additional column that Table 2 does not have. It is called “last” showing if a destination hood vehicle delivered last time in bulk to HCs or delivered to individuals. Since the former is a lot easier and quicker than the latter, it is only fair to alternate.

Table 1 below shows the Fair Fill Fleet (FFF) steps in priority order. It assigning the next vehicle to fill to capacity from the filtered pool. Then, steps 3 through 7 follow prioritized strategies to most optimally fill the chosen vehicle with the least fragmentation possible (minimizing column ‘Remaining at DC’ in the output tables) and optimally without having to drive to different locations to collect the packages (staying within the same row in input tables 4 and 5). The methods are explained in Table 1 with their actual use shown in output tables 6 and 7.

TABLE 1
Strategies & Methods for Optimally Allocating Packages to Vehicles

| STRATEGY METHOD | EXPLANATION |
|---|---|
| 1) Filter | filter veh (e.g. registered with HC and DC, isReady, |
| Vehicles | operating hours, need for special equipment, package |
| | wt/dimensions, etc.) |
| 2) Assign | use the FFF round-robin algorithm to pick next veh |
| Vehicle | |
| 3) EXACT | find an HC/DC cell with the number of packages equal |
| SINGLE | exactly to the capacity of the vehicle. |
| 4) EXACT SUM | if not found, find the least number of HC/DC cells the sum |
| | of which equals exactly the capacity of the vehicle, |
| | preferably from the same HC |
| 5) NEXT | if not found, find an HC/DC cell that is next larger than the |
| LARGER [SUM] | capacity of the vehicle |
| 6) LARGEST | if not found, find an HC/DC cell with the largest number less |
| SMALLER | than the capacity of the vehicle |
| 7) COMPLEMENT | Complement whatever is left to reach full vehicle capacity |

TABLE 2
INPUT -- SOURCE HOOD VEHICLES

| Org | Vehicle | capacity | Order |
|---|---|---|---|
| HF-a | HF-a1 | 11 | 2 |
| HF-a | HF-a2 | 20 | 6 |
| HF-b | HF-b1 | 33 | 4 |
| HF-b | HF-b2 | 9 | 7 |
| HF-b | HF-b3 | 9 | 8 |
| HN-x | HN-x | 3 | 1 |
| HN-y | HN-y | 4 | 3 |
| HN-z | HN-z | 11 | 5 |

TABLE 3
INPUT -- DESTINATION HOOD VEHICLES

| Org | Vehicle | capacity | last | Order |
|---|---|---|---|---|
| HF-c | HF-c1 | 19 | hc | 2 |
| HF-c | HF-c2 | 10 | cluster | 5 |
| HF-d | HF-d1 | 6 | hc | 4 |
| HF-d | HF-d2 | 17 | cluster | 6 |
| HF-d | HF-d3 | 55 | hc | 7 |
| HN-k | HN-k | 22 | cluster | 1 |
| HN-m | HN-m | 33 | hc | 3 |

TABLE 4
INPUT -- SOURCE HOOD PACKAGE COUNT, HC TO DC

DCs

| | FedEx | UPS | Amazon | WM | Target |
|---|---|---|---|---|---|
| HCs | DC0 | DC1 | DC2 | DC3 | DC4 |
| HC0 | 7 | 5 | 15 | 17 | 8 |
| HC1 | 2 | 1 | 3 | 38 | 4 |

Optimize by Source Hood (pickup everything from HC1, even when belonging to multiple DCs

TABLE 5
INPUT -- DESTINATION HOOD PACKAGE
COUNT, DC TO HC AND CLUSTERS

| | |
|---|---|
| TO HOOD | TO |
| CENTERS | CLUSTERS |

| FROM DC | HC0 | HC1 | HC2 | CL0 | CL1 |
|---|---|---|---|---|---|
| DC0, FedEx | 17 | 23 | 3 | 18 | 15 |
| DC1, UPS | 20 | 7 | 30 | 19 | 5 |

Optimize by Destination Hood (deplete HC from different DCs

TABLE 6
Source Hood Fair Fill Fleet Algorithm Output

| | Remaining | Remaining | Assigned | From | To | From | To | | Assignment Method |
|---|---|---|---|---|---|---|---|---|---|
| ID | at DC | at Vehicle | to Vehicle | pkg # | pkg # | HC | DC | Vehicle | Strategy |
| a | 0 | 0 | 3 | 1 | 3 | 1 | 2 | HN-x | method 3 EXACT |
| | | | | | | | | | SINGLE |
| b | 0 | 4 | 7 | 1 | 7 | 0 | 0 | HF-a1 | method 4 EXACT SUM |
| | | | | | | | | | (multi-source) |
| c | 0 | 0 | 4 | 8 | 11 | 1 | 4 | HF-a1 | method 4 EXACT SUM |
| | | | | | | | | | (multi-source) |
| d | 1 | 0 | 4 | 1 | 4 | 0 | 1 | HN-y | method 5 NEXT |
| | | | | | | | | | LARGER |
| e | 0 | 32 | 1 | 1 | 1 | 0 | 1 | HF-b1 | method 4 EXACT SUM |
| | | | | | | | | | (same source) |
| f | 0 | 17 | 15 | 2 | 16 | 0 | 2 | HF-b1 | method 4 EXACT SUM |
| | | | | | | | | | (same source) |
| g | 0 | 0 | 17 | 17 | 33 | 0 | 3 | HF-b1 | method 4 EXACT SUM |
| | | | | | | | | | (same source) |
| h | 0 | 3 | 8 | 1 | 8 | 0 | 4 | HN-z | method 4 EXACT SUM |
| | | | | | | | | | (multi-source) |
| i | 0 | 1 | 2 | 9 | 10 | 1 | 0 | HN-z | method 4 EXACT SUM |
| | | | | | | | | | (multi-source) |
| j | 0 | 0 | 1 | 11 | 11 | 1 | 1 | HN-z | method 4 EXACT SUM |
| | | | | | | | | | (multi-source) |
| k | 18 | 0 | 20 | 1 | 20 | 1 | 3 | HF-a2 | method 5 NEXT |
| | | | | | | | | | LARGER |
| l | 9 | 0 | 9 | 1 | 9 | 1 | 3 | HF-b2 | method 5 NEXT |
| | | | | | | | | | LARGER |
| m | 0 | 0 | 9 | 1 | 9 | 1 | 3 | HF-b3 | method 3 EXACT |
| | | | | | | | | | SINGLE |

Let's now delve into the assignment details starting with the source hood. So, we'll be working with tables 2 and 4. The vehicle tables 2 and 3 show the round-robin selection in the column ‘Order’. So, vehicle HN-x with capacity 3 is first selected. Using method 3) EXACT SINGLE, we match HN-x to Table 4 row 2 column 3 (the numbering is zero based, so it's HC1-DC2). Since this is an exact match, it leaves zeros for column ‘Remaining at Vehicle’ and ‘Remaining at DC’.

From Table 2, vehicle HF-a1 is next with capacity 11. We find an exact sum by adding 7 at HC0 destined to FedEx and 4 at HC1 destined to Target. Although we would've liked for all parts of the sum to be at the same HC, zero fragmentation is more important.

For HN-y with capacity 4, we use method 5 NEXT LARGER filling HN-y with the 4 it needs but leaving 1 extra at HC0 UPS, which is consumed when we switch to HF-b1 with capacity 33 in addition to the 15 and 17, all on the same row. This is ideal because we're able to fill HF-b1 to capacity from the same HC0.

Towards the end of priorities is when we resort to method 5 NEXT LARGER in the case of HF-a2 and HF-b2. Note that because the HF-b organization had more vehicles than all the others, it filled 2 of its vehicles b2 and b3 in sequence.

TABLE 7
Destination Hood Fair Fill Fleet Algorithm Output

| | Remaining | Remaining | Assigned | From | To | From | To | To | | Assignment Method |
|---|---|---|---|---|---|---|---|---|---|---|
| ID | at DC | at Vehicle | to Vehicle | pkg # | pkg # | DC | HC | Cluster | Vehicle | Strategy |
| n | 1 | 0 | 22 | 1 | 22 | 0 | 1 | | HN-k | method 5 NEXT LARGER |
| o | 0 | 0 | 19 | 1 | 19 | 1 | | 0 | HF-c1 | method 3 EXACT SINGLE |
| p | 0 | 15 | 18 | 1 | 18 | 0 | | 0 | HN-m | method 4 EXACT SUM |
| | | | | | | | | | | (same source) |
| q | 0 | 0 | 15 | 19 | 33 | 0 | | 1 | HN-m | method 4 EXACT SUM |
| | | | | | | | | | | (same source) |
| r | 0 | 1 | 5 | 1 | 5 | 1 | | 1 | HF-d1 | method 6 LARGEST |
| | | | | | | | | | | SMALLER |
| s | 0 | 7 | 3 | 1 | 3 | 0 | 2 | | HF-c2 | method 4 EXACT SUM |
| | | | | | | | | | | (multi-source) |
| t | 0 | 0 | 7 | 4 | 10 | 1 | 1 | | HF-c2 | method 4 EXACT SUM |
| | | | | | | | | | | (multi-source) |
| u | 0 | 0 | 17 | 1 | 17 | 0 | 0 | | HF-d2 | method 3 EXACT SINGLE |
| v | 0 | 25 | 30 | 1 | 30 | 1 | 2 | | HF-d3 | method 6 LARGEST |
| | | | | | | | | | | SMALLER |
| x | 0 | 5 | 20 | 31 | 50 | 1 | 0 | | HF-d3 | method 7 COMPLEMENT |
| y | 0 | 4 | 1 | 51 | 51 | 0 | 1 | | HF-d3 | method 7 COMPLEMENT |

Destination hood FFF follows similar logic except for the column ‘last’ in Table 3 which shows whether last time the vehicle was sent to a cluster or individual drop-off. Since HN-k went to a cluster last time, it is assigned its full capacity of 22 to an HC this time, leaving 1 package at DC0.

Next, HF-c1 luckily finds an exact cluster match of 19 to its full capacity, perfect match!

HN-m with capacity 33 went to an HC last time and must therefore be filled from a cluster, which also happens to be a perfect match, all coming from the same row DC0.

HF-d1 with capacity 6 must go to a cluster but can only be filled 5 out of 6 using method 6 LARGEST SMALLER because we cannot mix HC and Cluster drop-offs.

Now HF-c2 with capacity 10 must go to an HC since it went to cluster last time. Method 4 EXACT SUM finds cells DC0-HC2 with 3 packages and DC1-HC1 with 7 packages.

All remaining vehicles belong to HF-d and it's fair to fill them consecutively since there are no other vehicle suppliers. HF-d2 with capacity 17 finds the perfect EXACT SINGLE match. Then HF-d3 with capacity 55 is first assigned 30 using method 6 LARGEST SMALLER from DC1-HC2, 20 from DC1-HC0, and finally picking up the one left from before at DC0-HC1, leaving 4 package spaces unfilled since everything else has been consumed.

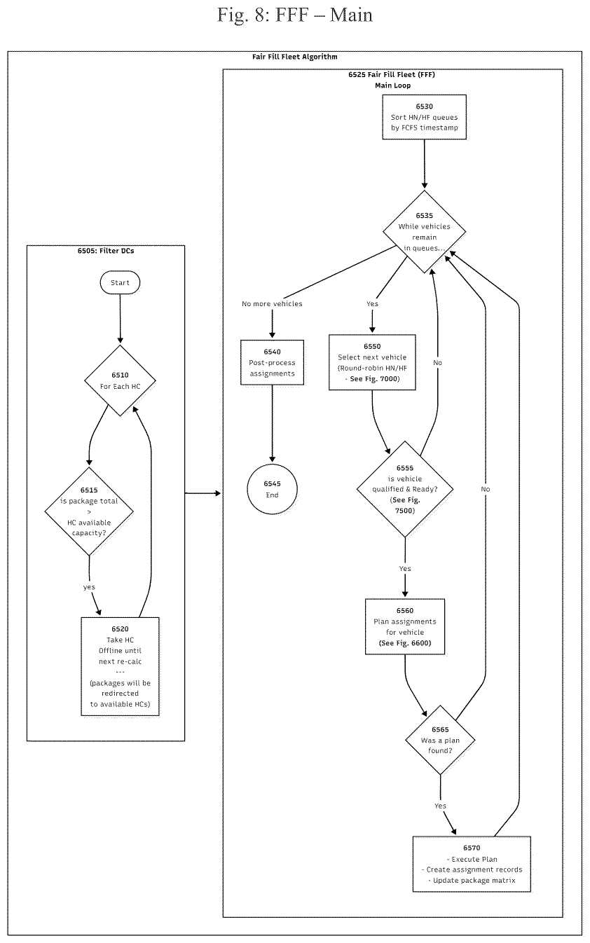

It is important to note, as shown in the main FIG. 8, that the FFF assignment process for the destination hood must start with checking the available capacity at HCs versus the total number of packages to be distributed. For instance, Table 5 shows that for HC1, there must be available capacity no less than 30=23+7. Say the available HC1 capacity is only 5. In that case, HC1 will be declared unavailable/offline for assignments until the next FFF re-calc when available capacity is checked again.

So, the body of Table 5 will now be

| | |
|---|---|
| TO HOOD | TO |
| CENTERS | CLUSTERS |

| FROM DC | HC0 | HC1 | HC2 | CL0 | CL1 |
|---|---|---|---|---|---|
| DC0, FedEx | 17 | [symbol] 0 | 3 | 18 | 15 |
| DC1, UPS | 20 | [symbol] 0 | 30 | 19 | 5 |

And the whole distribution changes to something like this:

TABLE 8
Assignment when HC1 is taken offline due lack of available capacity
Assignment when HC1 Is taken offline due to lack of available capacity

| | | | | | | | | | | Assignment | | |
|---|---|---|---|---|---|---|---|---|---|---|---|---|
| | Remaining | Remaining | Assigned | From | To | From | To | To | | Method | | Last |
| ID | at DC | at Vehicle | to Vehicle | pkg # | pkg # | DC | HC | Cluster | Vehicle | Strategy | capacity | Assigned |
| n | 8 | 0 | 22 | 1 | 22 | 1 | 2 | | HN-k | method 5 | 22 | cluster |
| | | | | | | | | | | NEXT | | |
| | | | | | | | | | | LARGER | | |
| o | 0 | 0 | 19 | 1 | 19 | 1 | | 0 | HF-c1 | method 3 | 19 | hc |
| | | | | | | | | | | EXACT | | |
| | | | | | | | | | | SINGLE | | |
| p | 0 | 15 | 18 | 1 | 18 | 0 | | 0 | HN-m | method 4 | 33 | hc |
| | | | | | | | | | | EXACT | | |
| | | | | | | | | | | SUM (same | | |
| | | | | | | | | | | source) | | |
| q | 0 | 0 | 15 | 19 | 33 | 0 | | 1 | HN-m | method 4 | 33 | hc |
| | | | | | | | | | | EXACT | | |
| | | | | | | | | | | SUM (same | | |
| | | | | | | | | | | source) | | |
| r | 0 | 1 | 5 | 1 | 5 | 1 | | 1 | HF-d1 | method 6 | 6 | hc |
| | | | | | | | | | | LARGEST | | |
| | | | | | | | | | | SMALLER | | |
| s | 7 | 0 | 10 | 1 | 10 | 0 | 0 | | HF-c2 | method 5 | 10 | cluster |
| | | | | | | | | | | NEXT | | |
| | | | | | | | | | | LARGER | | |
| t | 3 | 0 | 17 | 1 | 17 | 1 | 0 | | HF-d2 | method 5 | 17 | cluster |
| | | | | | | | | | | NEXT | | |
| | | | | | | | | | | LARGER | | |
| u | 0 | 47 | 8 | 1 | 8 | 1 | 2 | | HF-d3 | method 6 | 55 | hc |
| | | | | | | | | | | LARGEST | | |
| | | | | | | | | | | SMALLER | | |
| v | 0 | 40 | 7 | 9 | 15 | 0 | 0 | | HF-d3 | complement | 55 | hc |
| x | 0 | 37 | 3 | 16 | 18 | 0 | 2 | | HF-d3 | complement | 55 | hc |
| y | 0 | 34 | 3 | 19 | 21 | 1 | 0 | | HF-d3 | complement | 55 | hc |

Note that HF-d3's last assignment was to HC but since all Cluster assignments were consumed, HF-d3 was assigned HC again.

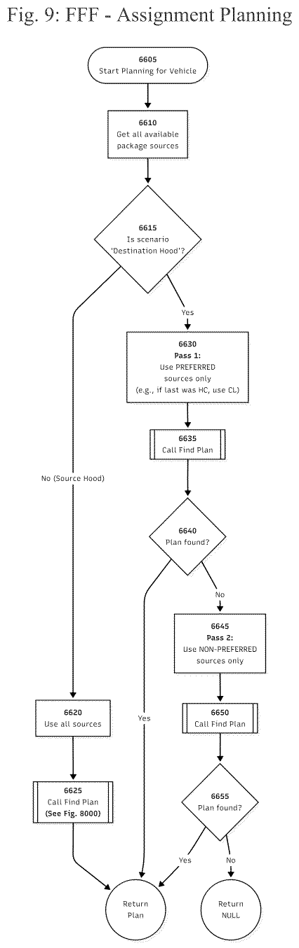

FIG. 9 shows how last assignment to HC or Cluster cannot be mixed and how it is attempted as pass 1 is done for the preferred assignment (HC if it was CL, or vice versa). If that doesn't work then we have to use the same assignment as last time as a contingency. This fairness rule is pretty challenging to implement but it is worth the effort.

### DETAILED DESCRIPTION

The present disclosure provides systems and methods for a cooperative e-commerce and logistics platform. The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

### System Architecture and Operational Paradigms

The invention is a comprehensive, computer-implemented framework managed by a central system, the e-Sellers Platform (eSP). The eSP coordinates a plurality of independent sellers, buyers, and logistics providers to solve key problems in the e-commerce ecosystem, namely monopolies (P1), inefficient returns (P2), and carrier redundancies (P3).

A foundational principle of the invention is its Decentralized, Non-Custodial Marketplace Architecture. The eSP system operates as a non-custodial, multi-sided platform, meaning it does not own, store, or take physical possession of any products. Each seller is responsible for storing and preparing their own products for shipment. The eSP functions as a computer-implemented coordination and information-brokering system that connects a plurality of independent sellers with a plurality of buyers and the cooperative logistics network. This decentralized architecture is a key element in solving the monopoly problem (P1), as it allows sellers of any size to participate without being required to use a centralized fulfillment service, thereby lowering the barrier to entry and fostering a more equitable marketplace.

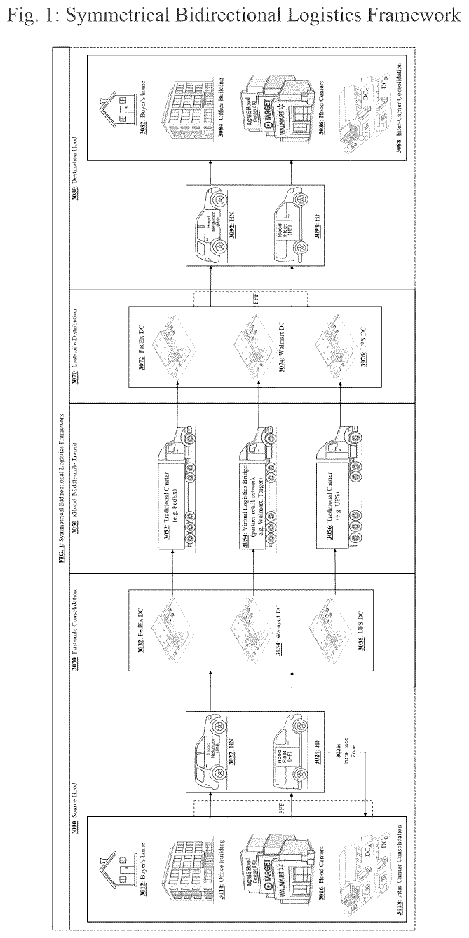

The overall architecture of the invention is best understood by reference to FIG. 1, which illustrates a Symmetrical Bidirectional Logistics Framework. A key inventive step of this architecture is the functional decoupling of local logistics operations (“hood”) from middle-mile transit (“xHood”). This segregation is the enabling foundation for the novel functionalities of the system.

The framework includes three primary operational modes within the “hood”:
1. First-Mile Operations: As shown in the Source Hood (3010), a cooperative fleet, comprising both Hood Neighbor (HN) vehicles (3022) and Hood Fleet (HF) vehicles (3024), performs consolidated pickups from disparate sources. These sources include a buyer's home for returns or new shipments (3012), offices (3014), Hood Centers (3016), and small local distribution centers (3018). The collected items are transported for First-Mile Consolidation (3030) at one or more carrier-specific distribution centers (DCs), such as a FedEx DC (3032), a Walmart DC (3034), or a UPS DC (3036)
2. Last-Mile Operations: As shown in the Destination Hood (3080), the cooperative fleet (3092, 3094) picks up packages from destination DCs (3072, 3074, 3076) for final delivery to various destinations, including a buyer's home (3082), an office (3084), Hood Centers (3086), or a small local distribution center (3088).
3. Intra-Hood Operations: As illustrated by the Intra-Hood Zone (3026), the cooperative fleet is also configured to perform transport tasks entirely within a single hood, bypassing the “xHood” layer. This is particularly useful for Inter-Carrier Consolidation (3018, 3088), where the fleet transports packages from one carrier's DC to another's within the same local area.

This symmetrical and bidirectional application of the “hood” model is an unconventional solution to carrier redundancy (P3) at the point of origin, destination, and at an inter-hub level.

From the consolidation hubs, packages enter the xHood: Middle-Mile Transit (3050) stage. The system supports transit via a Traditional Carrier Network (3052, 3056) or a novel Virtual Logistics Bridge (3054).

The entire system operates under an “Always-Priority” paradigm. As a computer-implemented method, the eSP abolishes conventional, multi-tiered shipping options. Instead, the system's logistics algorithms are configured with the primary objective of minimizing the total time from a customer's confirmed payment (“pay-click”) to final delivery (“door-bell”). This approach eliminates the operational fragmentation and inefficiencies inherent in tiered systems. In conjunction, the system implements an “Always-Free-to-DC” shipping rule for the middle-mile (“xHood”) portion, simplifying the customer experience by presenting the cost of this transit as free, while programmatically allocating the actual cost to the seller's account.

### The Fair Fill Fleet (FFF) Algorithm

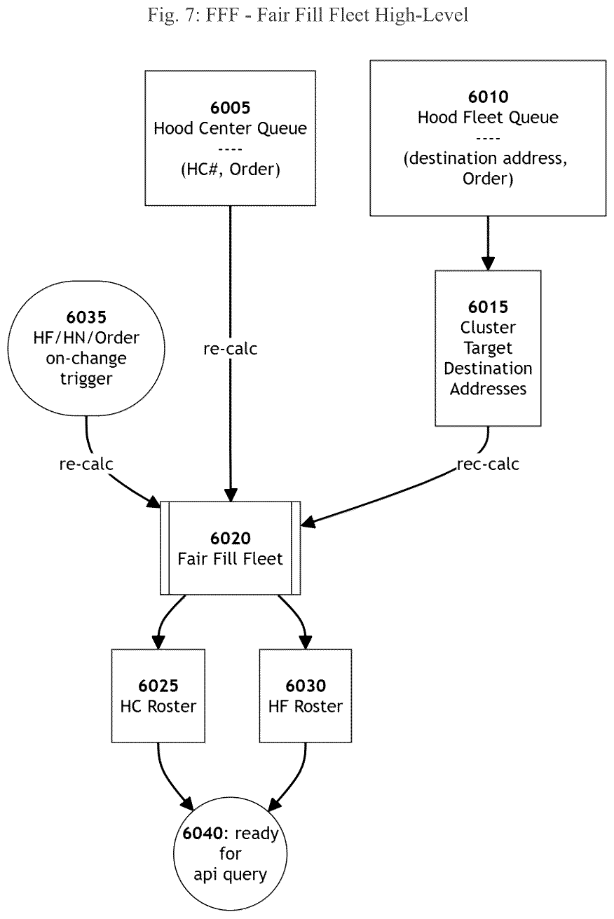

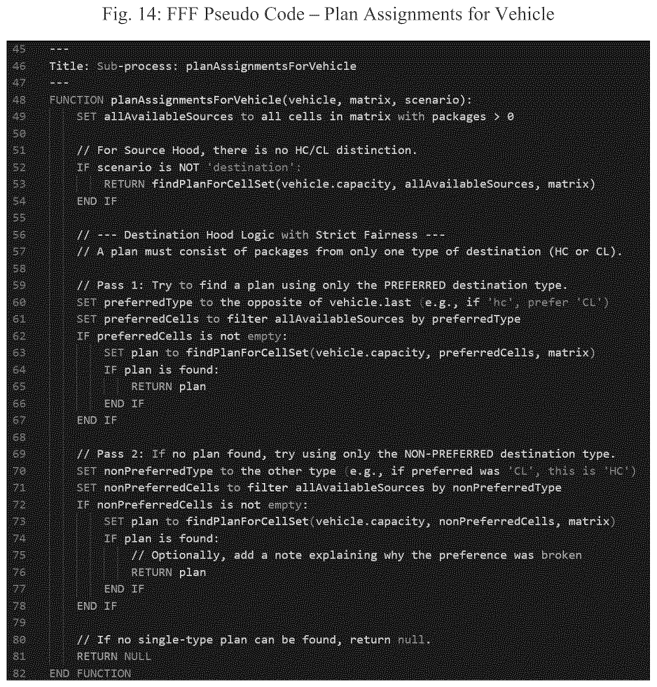

The assignment of vehicles in all “hood” operations is managed by a novel, multi-layered, computer-implemented method referred to as the Fair Fill Fleet (FFF) algorithm. This algorithm is the technical engine that enables the cooperative and equitable functioning of the logistics network. The high-level logic and detailed sub-processes of the FFF algorithm are illustrated in FIGS. 7, 8, 9, 10, 11, 12, 13, 14, and 15.

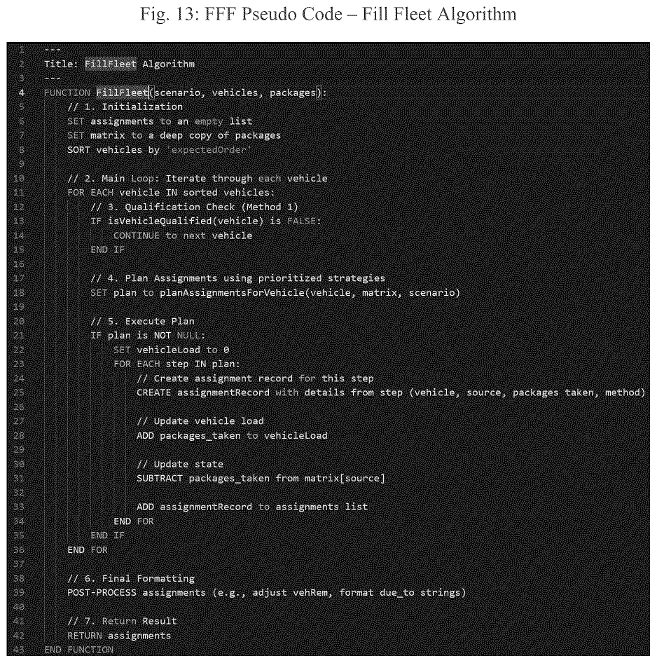

As shown in the main loop of the pseudo-code in FIG. 13, the FFF algorithm iterates through a sorted list of available vehicles to plan and execute assignments. The process for each vehicle involves a pre-processing and filtering stage, a vehicle selection module, and a package allocation module.

### Pre-Processing and Filtering

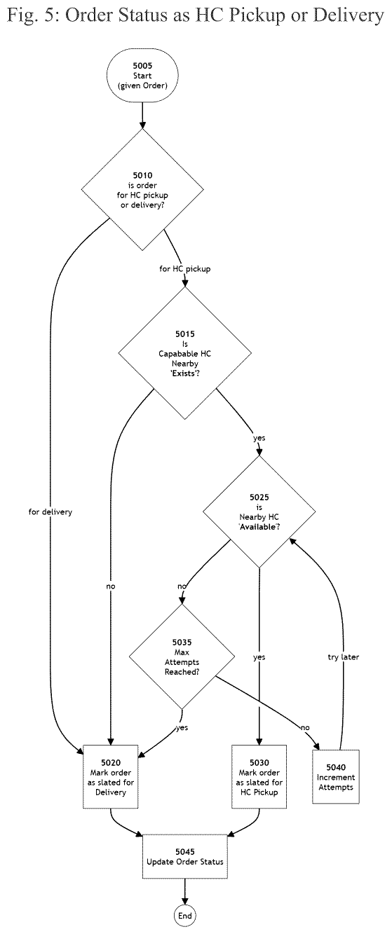

Before assignment, as shown in FIG. 8, the system performs a pre-processing step by matching pending orders to qualified Hood Centers (HCs) based on both static capabilities (e.g., specialEquipment, maxPackageLinearInches) and dynamic availability (e.g., operatingHours, capacityNow). Similarly, as shown in FIG. 5, the system filters the vehicle roster based on a distinction between static capabilities that “exist” and dynamic conditions of “availability”.

### Real-Time Vehicle Readiness and Status Management:

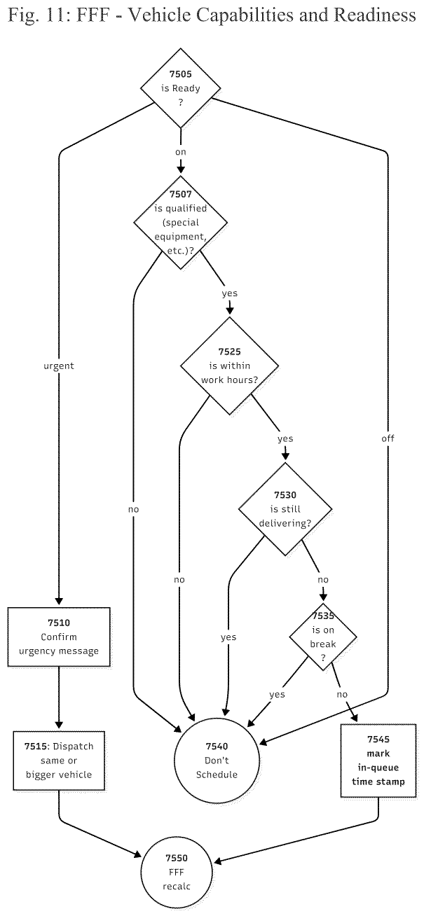

A key component of the Just-in-Time AI Logistics (JITAIL) system is the real-time management of vehicle readiness, the logic for which is detailed in the flowchart of FIG. 11. This process acts as a qualification gateway that each vehicle must pass before being considered. The process begins by querying the vehicle's operator-controlled isReady status (Step 7505), which can be ‘on’, ‘off’, ‘onBreak’, or ‘urgent’. If the status is ‘on’, the system proceeds through a series of qualification checks, including work hours (Step 7525) and current delivery status (Step 7530). Only if a vehicle passes all checks does the system mark its in-queue timestamp (Step 7545) for the “first-come-first-serve” tie-breaker and include it in the pool of available assets for the immediate FFF recalculation.

### Vehicle Selection Module

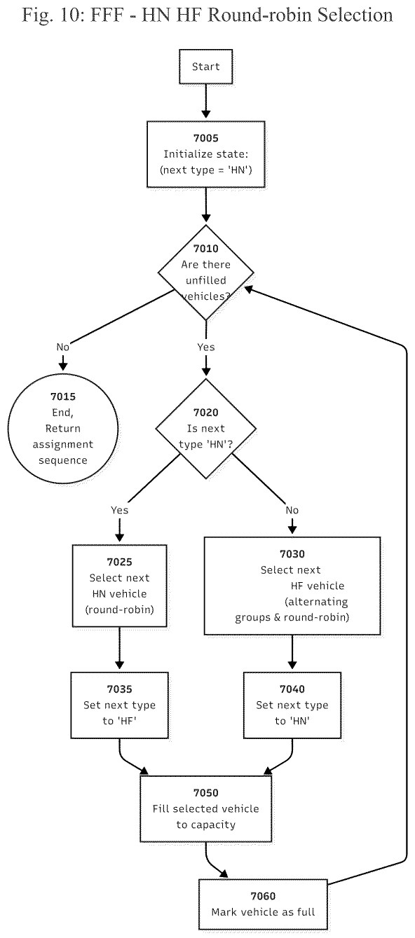

The vehicle selection module is configured with a first set of fairness rules. As shown in FIG. 10, the system maintains separate rosters for individual operators (Hood Neighbors (HN)) and multi-vehicle carriers (Hood Fleets (HF)). The algorithm alternates selection between these two classes (Steps 7020, 7035, 7040), ensuring smaller operators are not overlooked. When selecting from the HF class, the algorithm further alternates between distinct carrier entities to maintain fairness among larger competitors (Step 7030). To resolve any ties, the system applies a “first-come-first-serve” tie-breaking rule based on the timestamp recorded when a vehicle becomes ready (Step 7540). For destination hood scenarios, as detailed in FIG. 9, the vehicle selection module incorporates an additional fairness rule, preferentially assigning a vehicle to a delivery type (e.g., bulk HC delivery vs. distributed cluster delivery) opposite to its last status to ensure an equitable distribution of task difficulty over time.

### Package Allocation Module

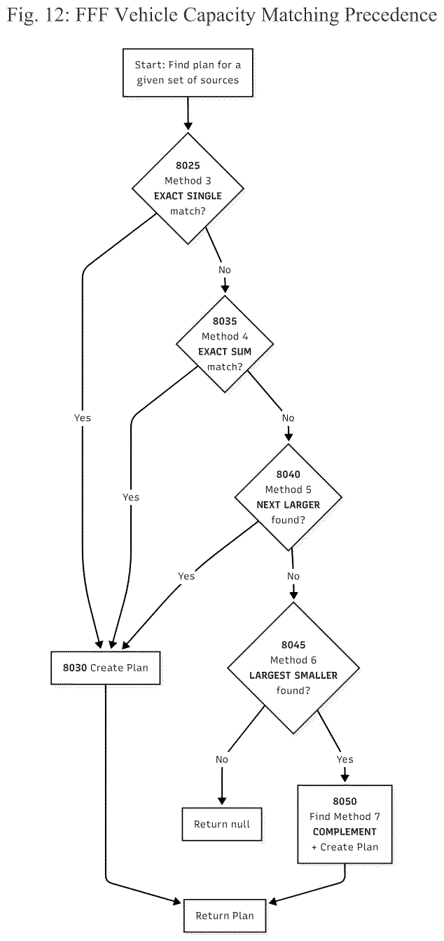

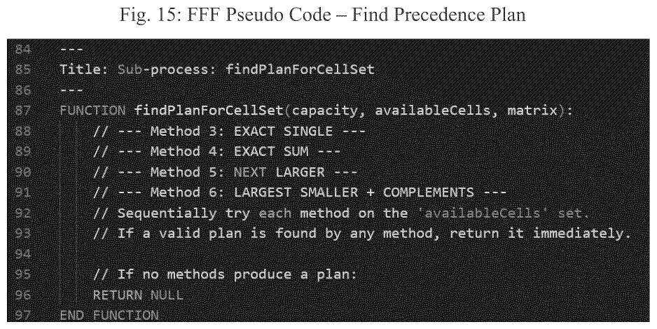

Once a vehicle is selected, the package allocation module, detailed in FIG. 12 and the pseudo-code of FIG. 15, assigns packages to fill the vehicle to capacity. This is achieved by applying a second set of prioritized rules designed to optimize the fill while minimizing fragmentation. The prioritized sequence of package allocation strategies, as described in Table 1, is a non-obvious heuristic for solving this complex allocation problem. The strategies are applied in order of precedence, from most to least optimal: EXACT SINGLE (Method 3), EXACT SUM (Method 4), NEXT LARGER (Method 5), and LARGEST SMALLER (Method 6) with COMPLEMENT (Method 7).

### E-Commerce and User Interaction Methods

### Modification of Checkout Process:

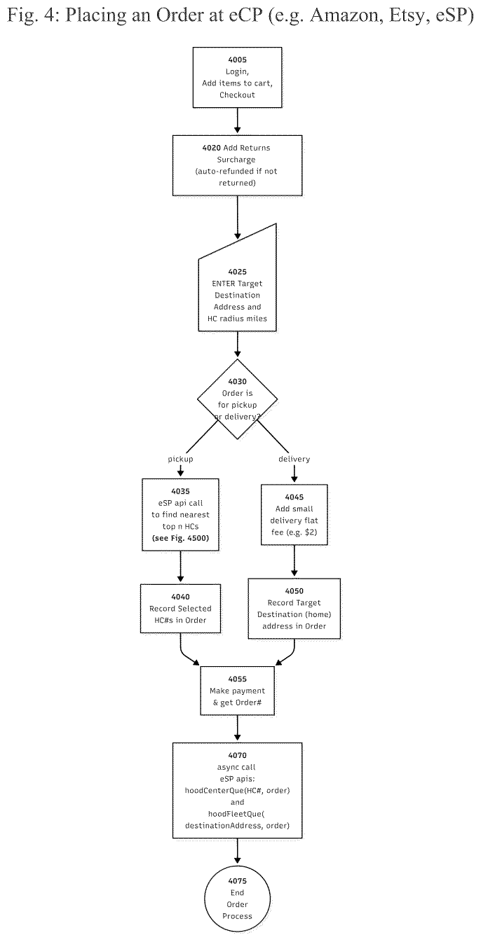

FIG. 4 illustrates the novel modifications to a standard e-commerce checkout flow. The system adds a distinct Returns Surcharge (Step 4520) with an auto-refund promise, transparently addressing the returns problem (P2). When a user chooses fulfillment (Step 4530), they are presented with options enabled by the cooperative network: either pickup at a nearby Hood Center (HC) (Step 4535) or home delivery (4545), which incurs a small, predetermined delivery flat fee (Step 4545). This fee acts as a behavioral incentive to encourage HC pickups. Finally, upon payment (Step 4555), the system makes an asynchronous API call to the eSP (Step 4570) to initiate the FFF fulfillment process.

### Cooperative Pickup by Authorized Agents:

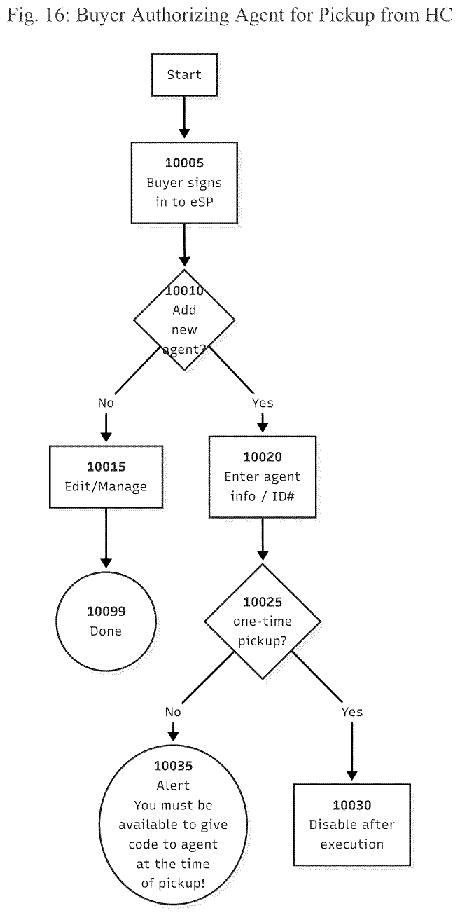

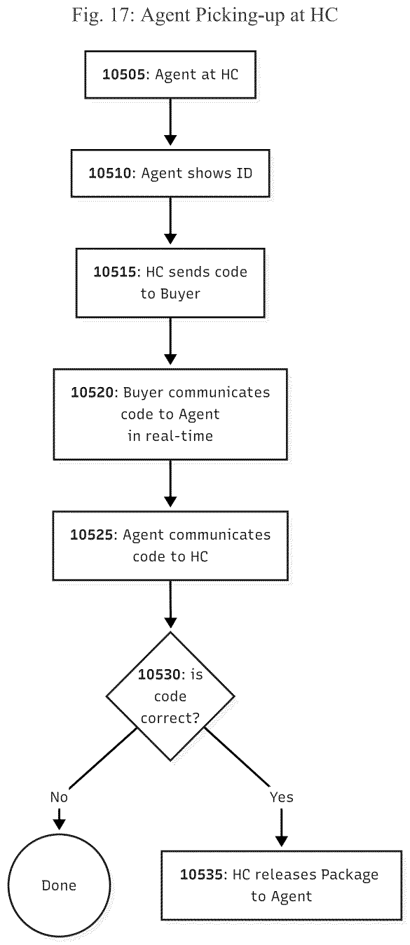

The “Hood Neighbor” concept is expanded to include a trusted personal network of agents. FIG. 16 details the computer-implemented system for a buyer to manage a roster of these designated agents via the eSP. To enable this, the invention provides a novel, secure verification protocol, detailed in FIG. 17. This protocol is a real-time, three-party, two-factor authentication method for a physical asset. When an agent is at an HC (Step 10505), the system transmits a secure, time-sensitive code directly to the Buyer's device (Step 10515). The Buyer must then communicate this code to the Agent (Step 10520), who in turn provides it to the HC system for verification (Step 10525). The package is released only upon a successful match (Step 10535).

### System Embodiments and Advanced Features

### Virtual Logistics Bridge:

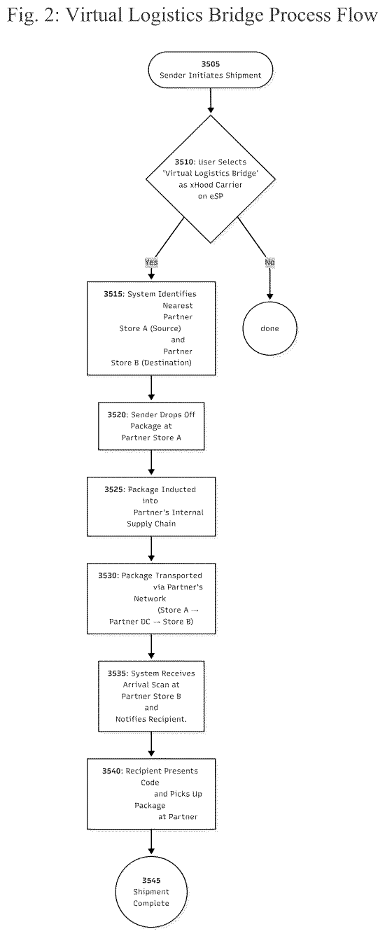

As shown in FIG. 1 (item 3054) and detailed in FIG. 2, the “xHood” transit layer can be embodied as a Virtual Logistics Bridge, leveraging the internal logistics network of a partner retail entity.

### Automated and Modular Hood Centers:

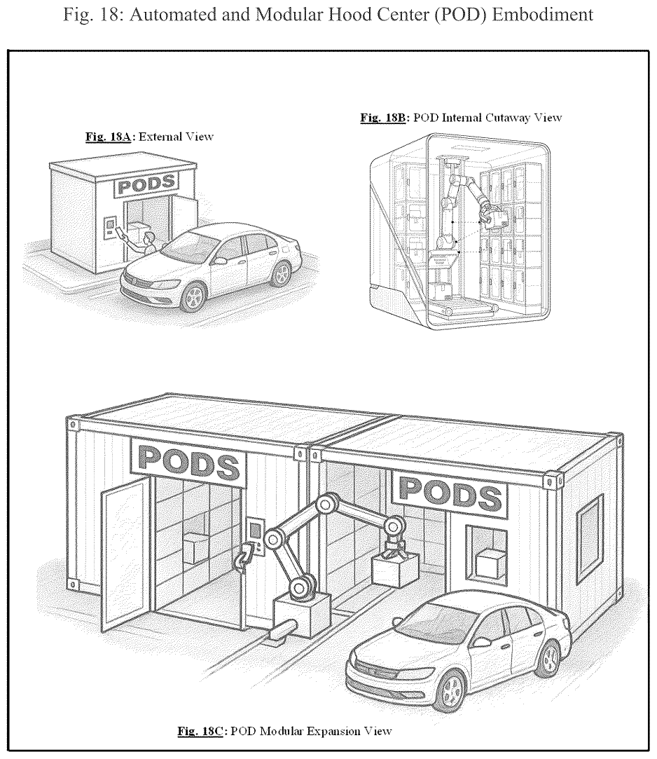

As detailed in FIGS. 18A-18C, a Hood Center may be embodied as a standalone, automated, and modular logistics hub or “POD”. These units can feature a drive-through (FIG. 18A), an internal robotic package handling system (FIG. 18B), and can be configurably expanded by coupling additional units (FIG. 18C).

### Dynamic Optimization via JITAIL:

The eSP functions as a dynamic, real-time logistics management system, or “Just-in-Time AI Logistics” (JITAIL). As detailed in FIG. 7 and FIG. 11, the system continuously monitors real-time data, including a vehicle's isReady status flag. Upon detecting a disruption event (6035), such as a vehicle's isReady flag changing, the JITAIL system automatically triggers a recalculation by re-executing the FFF algorithm with the most current data to generate and dispatch a modified logistics plan.

### Systemic Optimization of Hood Center Performance

To ensure the integrity of the “always-priority” paradigm, the invention includes a computer-implemented method for optimizing HC performance by reducing package “flooring” time. The eSP system captures timestamps for package arrival and pickup at an HC, calculates the storage duration, and uses this as a performance metric. This metric is then used as a modifying factor in the Cooperative Financial and Governance Method, rewarding more efficient HCs with a proportionally larger share of any operational surplus.

### Cooperative Framework and Governance

### Open-Source Platform:

A central tenet of the invention is that the eSP software is implemented within an open-source framework to ensure transparency and foster cooperation. The patent rights are used defensively to enforce a reciprocal open-source license, preventing any single entity from creating a closed, proprietary version of the network.

### Cooperative Financial Model:

The invention includes a computer-implemented financial method to sustain the cooperative ecosystem. The eSP's financial reconciliation module programmatically tracks all operational revenues and costs to determine a net surplus or deficit. In the event of a surplus, a distribution algorithm automatically allocates a predetermined share among all key stakeholder classes (Active Sellers, HCs, HFs, HNs) based on their tracked participation metrics. This automated, rule-based system turns logistical partners into financial partners, providing the ultimate incentive for cooperation and ensuring the long-term viability of the ecosystem.

### System Data Structures

The methods of the invention are enabled by a plurality of data structures stored in a computer-readable memory. As detailed in the provided data schema below, these structures define the entities and their operational parameters. Key entities include the Hood Center (HC), with fields for automation capabilities and special equipment; the Hood Fleet (HF), with a detailed array of vehicle objects specifying capacity and special equipment; the Hood Neighbor (HN)/Agent, with fields for authorization status; the Buyer, with a list of authorized agents; and the Package/Order, with fields for handling requirements and returns information. These structures provide the informational foundation for the eSP to execute the various methods of the invention. The key data entities include, but are not limited to, the following:

### Hood Center (HC) Data Structure:

Represents a physical location for package consolidation and exchange.
HC_ID: A unique identifier for the Hood Center.
company_info: A data object containing name, address, and contact information.
operation_times: Data defining the hours and days of operation.
package_constraints: Parameters defining physical limits, including and max_weight_per_package, max_linear_dimensions_per_package, package_capacity_count.
automation_capabilities: A set of boolean flags indicating the level of automation, such as is_location_POD_Exchange_ready, is_location_fully_robotically_automated_for_customer_pickup, and is_location_fully_robotically_automated_for_Carrier_pickup_drop_off, as described in relation to FIGS. 18A-18C.
expandability_metrics: Data defining the potential for scaling, including available_area_sq_ft, area_expandability_sq_ft, POD_expandability_total, and associated time frames.
special_equipment: An array of data objects specifying capabilities for handling sensitive goods, such as {type: “refrigeration”, capacity_cu_ft: 500} or {type: “freezer”, capacity_cu_ft: 200}.

### Hood Fleet (HF) Data Structure:

Represents a commercial carrier entity participating in the cooperative network.
HF_ID: A unique identifier for the Hood Fleet entity.
company_info: A data object containing name, address, and contact information.
operation_times: Data defining the hours and days of operation.
fleet_vehicles: An array of vehicle data objects, each containing:
   vehicle_ID: A unique identifier for the vehicle (e.g., plate number).
   is_EV: A boolean flag indicating if the vehicle is electric.
   capacity: The total unit capacity of the vehicle.
   special_equipment: An array of data objects specifying capabilities, such as {type: “fridge”, capacity: 100} or {type: “lift_gate”, capacity: 1000}.
   isReady: A real-time status flag (‘on’, ‘off’, ‘onBreak’, ‘urgent’) controlled by the operator and monitored by the JITAIL system, as described in relation to FIG. 11.
   in_queue_timestamp: A timestamp marking when the vehicle became available, used for the “first-come-first-serve” tie-breaking rule.
registered_HCs: An array of HC_IDs where the fleet is authorized to operate.

### Hood Neighbor (HN)/Agent Data Structure:

Represents an individual or small-scale participant, including authorized agents from a buyer's personal network.
HN_ID: A unique identifier for the Hood Neighbor or Agent.
agent_info: A data object containing name and contact information.
authorizing_buyer_ID: A reference to the Buyer_ID that authorized this agent.
authorization_status: A field indicating the agent's status (e.g., ‘active’, ‘one-time_pending’, ‘disabled’), as managed via the process in FIG. 16.
vehicle_info: A data object describing the agent's vehicle, including capacity and any special equipment.
isReady: A real-time status flag (‘on’, ‘off’, ‘onBreak’, ‘urgent’) as described for HF vehicles.
in_queue_timestamp: A timestamp as described for HF vehicles.
registered_HCs: An array of HC_IDs where the agent is authorized to operate.

### Buyer/User Data Structure:

Represents an end-customer using the eSP.
Buyer_ID: A unique identifier for the buyer.
user_info: A data object containing name, delivery addresses, and contact information.
payment_info: Securely stored payment methods.
authorized_agents: An array of HN_IDs representing agents the buyer has authorized for pickup, directly linking to the Agent Management system described in FIG. 16.

### Package/Order Data Structure:

Represents a single order or package moving through the system.
Order_ID: A unique identifier for the order.
Buyer_ID: The identifier of the purchasing customer.
eCP_ID: The identifier of the original e-Commerce Platform.
package_status: A field tracking the package's real-time status (e.g., ‘awaiting_pickup’, ‘in_transit_xHood’, ‘at_destination_HC’, ‘out_for_delivery’, ‘delivered’, ‘return_initiated’).
special_equipment: An array of data objects specifying capabilities, such as {type: “fridge”, capacity: 100} or {type: “lift_gate”, capacity: 1000}.
assigned_vehicle_ID: The identifier of the HF or HN vehicle currently responsible for the package.
returns_info: A data object for managing returns, including returns_surcharge_amount, return_window_expiration_datetime, and refund_status, as required by the process in FIG. 4.
e arrival_at_HC_timestamp: the time when packages are dropped off by an HN/HF at an HC.
pickup_from_HC_timestamp: the time when a package is released to a customer or an agent.

These data structures provide the informational foundation for the eSP to execute the various methods of the invention, including filtering capable vehicles for specialized deliveries, managing a roster of authorized agents, and tracking the lifecycle of an order and its potential return.

### Systemic Optimization of Hood Center Performance

To ensure the integrity of the “always-priority” paradigm and minimize the total “click-to-door” time, the present invention includes a computer-implemented method for systemically optimizing the performance of Hood Centers (HCs) by reducing package storage or “flooring” time. This is achieved by integrating a performance metric based on pickup speed directly into the cooperative financial model.

The eSP system is configured to capture a first timestamp when a package arrives and is scanned at a destination HC, and a second timestamp when the package is picked up by the end customer or their designated agent (as in the process of FIG. 17). The processor calculates the delta between these timestamps to determine a “flooring time” for each package. This data is aggregated for each HC to generate an average flooring time metric, which serves as a key performance indicator (KPI) for that HC's efficiency.

This flooring time KPI is then used as a modifying factor in the Cooperative Financial and Governance Method. When the system's financial reconciliation module calculates the distribution of an operational surplus, an HC's share is determined not only by its transaction volume but also by its flooring time performance metric. HCs with lower average flooring times (indicating faster pickups) may receive a proportionally larger share of the surplus, thereby creating a direct financial incentive to facilitate prompt package collection.

In a further embodiment, the eSP provides a software module or Application Programming Interface (API) that empowers HCs to create their own customer-facing incentives. For example, an HC, such as a hypermarket, can use this module to configure a rule that automatically offers a digital coupon or in-store discount to any buyer who picks up their package from the HC within a predetermined time window (e.g., within 12 hours of arrival). This window may be configured to automatically change according to available space. The eSP system then communicates this dynamic offer to the buyer's computing device, further encouraging rapid pickups, increasing foot traffic for the local business, and ensuring the optimal integration and velocity of the entire logistics network.

### Conclusion, Ramifications, and Scope

The present disclosure provides for a comprehensive, computer-implemented system and method that fundamentally re-configures the e-commerce and logistics landscape from a series of siloed, competing entities into a single, cooperative, and highly efficient ecosystem. The ramifications of this invention are far-reaching, extending beyond simple optimization to create new value from existing infrastructure and level the playing field for participants of all sizes.

A primary ramification of the disclosed system is the intelligent re-configuration of existing logistics services. As large e-Commerce Platforms (eCPs) integrate with the eSP and adopt the hood/xHood model, their traditional, proprietary last-mile delivery fleets become operationally inefficient for their own needs. The architectural decoupling of the present invention transforms this challenge into an opportunity. The “excess” or “underutilized” vehicle capacity of these eCPs, which would otherwise represent a sunk cost, can be seamlessly integrated into the cooperative “hood” network as Hood Fleets (HFs). As illustrated in the Symmetrical Bidirectional Logistics Framework (FIG. 1), these assets are then managed by the Fair Fill Fleet (FFF) algorithm (FIGS. 7 to 15) to serve the entire network's demand, including demand from competing eCPs and small, independent sellers. This transforms a competitive asset into a shared, revenue-generating resource, solving the carrier redundancy problem (P3) by absorbing latent capacity into a single, optimized local network.

The scope of the invention is not limited to the transport of general parcels. By incorporating data structures that track the specialized capabilities of vehicles and Hood Centers (HCs)—such as refrigeration or warming units—the system can be applied to on-demand local commerce, including the delivery of groceries, restaurant meals, and pharmaceuticals. The dynamic, real-time nature of the system, managed by the Just-in-Time AI Logistics (JITAIL) module and the vehicle readiness protocols (FIG. 11), makes it ideally suited for these time-sensitive applications.

Furthermore, the scope of the cooperative fleet is not limited to commercial carriers. The system is designed to integrate a social logistics layer through the “Hood Neighbor” concept. The methods for managing a roster of trusted personal agents (FIG. 16) and the novel, three-party secure verification protocol for package pickup (FIG. 17) provide the technical foundation for a secure, community-based delivery network that operates alongside commercial providers.

The physical infrastructure of the invention is also broad in scope. The Hood Center is not a proprietary facility but a role that can be assumed by any local business, creating a vast, decentralized network of logistics hubs. This is further enhanced by the embodiment of HCs as automated, modular, and drive-through PODs (FIGS. 18A-18C), which allows for rapid and scalable deployment. The middle-mile layer is similarly flexible, capable of utilizing not only traditional carriers but also the internal supply chains of retail partners via the Virtual Logistics Bridge (FIG. 2).

Ultimately, the disclosed invention provides the technical blueprint for a new type of commercial ecosystem. It is a multi-sided platform that, through its unique architectural design, novel algorithms, and cooperative business methods-including the open-source platform and the automated cost/profit sharing plan-creates a self-sustaining, transparent, and fair marketplace. It re-configures existing services and assets to unlock new efficiencies, providing a robust and scalable solution to the fundamental problems of modern e-commerce.

I claim:

1. A computer-implemented method for managing a bidirectional and multi-modal cooperative logistics network, the method comprising:
receiving, by a processor, a plurality of pickup requests for packages to be collected from a plurality of disparate package sources within a first geographic area, said first geographic area defining a source hood;
receiving, by the processor, a plurality of delivery requests for packages to be delivered to a plurality of destinations within a second geographic area, said second geographic area defining a destination hood;
maintaining, by the processor in a data store, a roster of a cooperative fleet of vehicles available for dispatch, said cooperative fleet comprising vehicles from a plurality of distinct and competing carrier entities; and
applying, by the processor, a Fair Fill Fleet (FFF) assignment algorithm to the cooperative fleet of vehicles to select and dispatch:
one or more vehicles to perform consolidated pickup routes within the source hood, wherein a single consolidated pickup route services multiple of said disparate package sources for first-mile consolidation at one or more distribution centers;
one or more vehicles to perform delivery routes from one or more distribution centers within the destination hood; and
one or more vehicles to perform intra-hood transport routes between two distribution centers located within the same geographic area.

2. The method of claim 1, wherein said plurality of disparate package sources comprises at least one of: a local business, a logistics hub, an at-home return pickup location, and a distribution center of a first carrier entity for transport to a distribution center of a second carrier entity within the same source hood.

3. The method of claim 1, wherein the FFF assignment algorithm comprises:
a vehicle selection module configured to select a next vehicle for assignment from the cooperative fleet based on a first set of fairness rules; and
a package allocation module configured to, after a vehicle is selected, assign a set of packages to the selected vehicle by applying a second set of prioritized rules designed to optimize filling the vehicle to capacity while minimizing fragmentation of package sources or destinations.

4. The method of claim 3, wherein the first set of fairness rules of the vehicle selection module comprises:
maintaining separate rosters for a first class of vehicles associated with individual operators (HNs) and a second class of vehicles associated with multi-vehicle carriers (HFs);
alternating the selection of the next vehicle between the first class of vehicles and the second class of vehicles; and
applying a first-come-first-serve tie-breaking rule to select a vehicle from within a class when multiple vehicles are equally eligible for selection.

5. The method of claim 4, wherein the first-come-first-serve tie-breaking rule is based on a timestamp recorded by the processor at a time each vehicle indicates its availability for dispatch.

6. The method of claim 4, wherein selecting a vehicle from the second class of vehicles further comprises alternating selection between distinct carrier entities within said second class.

7. The method of claim 3, wherein the second set of prioritized rules of the package allocation module comprises a prioritized sequence of package allocation strategies, said sequence comprising:
first, attempting to identify a single package source having a quantity of packages that exactly matches a capacity of the selected vehicle; and
if no exact single source match is identified, subsequently attempting to identify a plurality of package sources having a combined quantity of packages that exactly matches the capacity of the selected vehicle.

8. The method of claim 7, wherein the prioritized sequence of package allocation strategies further comprises:
if no exact sum match is identified, subsequently attempting to identify a single package source having a quantity of packages that is the next largest quantity compared to the capacity of the selected vehicle.

9. The method of claim 3, wherein applying the FFF assignment algorithm to the destination hoods further comprises:
maintaining a last delivery type status for each vehicle, said status indicating whether a vehicle's previous delivery was to a consolidated hub or a distributed cluster of individual destinations; and
wherein the vehicle selection module preferentially assigns a vehicle to a delivery type opposite to its last delivery type status to ensure fairness of task difficulty.

10. A computer-implemented method for managing reverse logistics within a cooperative forward logistics network, the method comprising:
receiving, by a processor from a customer computing device, a request to return an item associated with a prior purchase, said request identifying a customer location;
generating, by the processor, a return pickup task associated with said customer location;
adding, by the processor, said return pickup task to a dispatch queue comprising a plurality of forward delivery tasks for a geographic area containing said customer location;
applying, by the processor, a vehicle assignment algorithm to a cooperative fleet of vehicles to select a vehicle to perform said return pickup task, wherein said selected vehicle is concurrently assigned at least one forward delivery task from said dispatch queue; and
transmitting, by the processor, routing instructions to a computing device associated with said selected vehicle to execute both said return pickup task and said at least one forward delivery task in a single trip.

11. The method of claim 10, wherein the customer is not required to provide packaging or a shipping label for the returned item, and wherein said packaging and labeling is performed at a local consolidation hub.

12. A computer-implemented method for providing a virtual logistics bridge, the method comprising:
receiving, by a processor from a sender's computing device, a request to transport a package to a recipient;
identifying, by the processor from a plurality of retail store locations, a first retail store location proximate to the sender and a second retail store location proximate to the recipient, wherein the first and second retail store locations are operated by a single retail entity having an internal logistics network for transporting goods between its locations;
generating, by the processor, instructions for the sender to deposit the package at the first retail store location;
transmitting, by the processor, a set of electronic instructions to the internal logistics network of the retail entity, said instructions causing the internal logistics network to transport the package from the first retail store location to the second retail store location; and
transmitting, by the processor to the recipient's computing device, a notification that the package is available for pickup at the second retail store location.

13. The method of claim 12, wherein the package is transported from the first retail store location to the second retail store location on a vehicle that is concurrently transporting merchandise belonging to the retail entity.

14. A modular and automated logistics hub for package exchange, the hub comprising:
a first self-contained housing unit comprising a plurality of secure package compartments;
at least one external access portal;
a robotic package handling system disposed within the housing, said system configured to transport packages between the at least one external access portal and the plurality of secure package compartments;
a user interface configured to receive authentication data from a user;
a processor configured to, upon successful authentication of the user, control the robotic package handling system to perform a package exchange operation via the at least one external access portal; and
a communication interface for transmitting transaction data to a remote logistics management server.

15. The modular and automated logistics hub of claim 14, wherein the housing is configured to be installed in an outdoor location and is further configured with a drive-through lane to allow a user to access the user interface from within a vehicle.

16. The modular and automated logistics hub of claim 14, wherein the first self-contained housing unit is a base modular unit, and further comprising a docking interface configured to physically and communicatively couple the base modular unit with at least one second modular unit to expand the total number of secure package compartments.

17. A computer-implemented method for the secure release of a package to a designated agent, the method comprising:
receiving, by a processor at a package holding facility from a person acting as an agent, a first set of identifying information;
verifying, by the processor, that the agent is associated with a specific package designated for a buyer;
in response to said verification, transmitting, by the processor, a secure, time-sensitive authentication code to a communication device registered to the buyer of the specific package;
receiving, by the processor from the agent, a second authentication code, wherein said second authentication code is communicated to the agent by the buyer in real-time;
comparing, by the processor, the second authentication code with the transmitted secure, time-sensitive authentication code; and
authorizing, by the processor, the release of the specific package to the agent only if the second authentication code matches the transmitted secure, time-sensitive authentication code.

18. The method of claim 17, further comprising:
prior to the agent arriving at the package holding facility, receiving, by a central server from the buyer via a user interface, a request to authorize the agent to pick up the specific package, said request including the first set of identifying information for the agent.

19. A computer-implemented method for managing a cooperative logistics network with specialized assets, the method comprising:
maintaining, by a processor in a data store, a roster of a plurality of vehicles available for dispatch, said roster comprising vehicles from a plurality of distinct carrier entities, wherein the roster includes capability data for each vehicle specifying any special handling equipment associated therewith;
receiving, by the processor, a delivery request for an item, said request including requirement data specifying a special handling condition for the item;
filtering, by the processor, the roster of vehicles to identify a sub-roster of capable vehicles, wherein each capable vehicle has capability data that satisfies the requirement data of the item; and
applying, by the processor, a fairness-based assignment algorithm to the sub-roster of capable vehicles to select and dispatch one of said capable vehicles to transport the item.

20. A computer-implemented method for dynamic management of a cooperative logistics network, the method comprising:
generating, by a processor, an initial set of pickup and delivery assignments for a cooperative fleet of vehicles using a fairness-based assignment algorithm, said cooperative fleet comprising vehicles from a plurality of distinct entities;
transmitting, by the processor, said initial assignments to computing devices associated with said vehicles;
subsequent to transmitting said initial assignments, receiving, by the processor, a continuous stream of real-time status data from the plurality of vehicles, wherein said status data includes an operator-controlled isReady status flag for each vehicle indicating its availability for dispatch;
detecting, by the processor, a disruption event, wherein said disruption event comprises receiving a signal indicating a change in the isReady status flag of an assigned vehicle;
in response to detecting said disruption event, automatically re-executing, by the processor, the fairness-based assignment algorithm using the real-time status data to generate a modified set of assignments for at least a portion of the cooperative fleet; and
transmitting, by the processor, the modified set of assignments to the affected vehicles.

21. The method of claim 20, wherein the isReady status flag has a plurality of states including an ‘on’ state indicating availability, an ‘off’ state indicating non-availability, an ‘onBreak’ state indicating temporary unavailability, and an ‘urgent’ state indicating an immediate need for recalculation.

22. The method of claim 20, further comprising:
collecting historical performance data related to the execution of said assignments by the cooperative fleet;
training a machine learning model using said historical performance data to generate predictive logistics estimates; and
using said predictive logistics estimates as an input when generating the initial set of assignments to improve accuracy.

23. A computer-implemented method for managing a logistics network, the method comprising:
receiving, by a processor of a central server from a customer computing device, an order for a product, wherein the order does not include a customer selection from a plurality of shipping speed options;
in response to receiving the order, automatically assigning, by the processor, a single priority status to the order;
executing, by the processor, a logistics dispatch algorithm configured with a primary objective function to minimize a total time duration from a time of payment confirmation for the order to a time of final delivery of the product;
receiving, by the processor from a plurality of mobile computing devices associated with a plurality of distinct logistics providers, a series of timestamped status updates corresponding to a plurality of stages in a fulfillment process for the order; and
calculating, by the processor, a set of performance metrics for each of the plurality of distinct logistics providers by determining the time elapsed between consecutive ones of the timestamped status updates.

24. A computer-implemented method for managing a cooperative e-commerce ecosystem, the method comprising:
maintaining, by a processor in a data store, a plurality of participant accounts, wherein said accounts are classified into a plurality of distinct stakeholder classes, and wherein at least one of said classes is designated as a cost/profit sharing participant;
tracking, by the processor, all operational revenues and operational costs associated with the e-commerce ecosystem over a defined time period;
calculating, by the processor at the end of the time period, a net operational balance by subtracting the operational costs from the operational revenues;
if the net operational balance is a deficit, automatically executing, by the processor, a cost allocation module to distribute a share of the deficit to participant accounts designated as cost/profit sharing participants; and
if the net operational balance is a surplus, automatically executing, by the processor, a surplus distribution module to distribute a share of the surplus to a plurality of the distinct stakeholder classes based on stored participation metrics for each participant.

25. A computer-implemented method for managing a cooperative e-commerce and logistics network, the method comprising:
maintaining, by a processor in a data store, a plurality of seller accounts, wherein each seller is responsible for storing and preparing its own products for shipment, and wherein the system does not operate any physical warehouses for storing said products;
receiving, by the processor from a buyer computing device, an order for a product from one of the sellers;
presenting, by the processor to the buyer computing device, a final purchase price for the order that includes a zero-dollar charge for a middle-mile shipping segment, said middle-mile segment comprising transit from a source distribution center to a destination distribution center;
processing a payment from the buyer for the final purchase price; and
programmatically allocating, by the processor, a cost associated with said middle-mile shipping segment to the account of the seller of the product.

26. The method of claim 25, wherein the final purchase price presented to the buyer further includes a distinct line item for a returns surcharge, said surcharge being subject to an automatic refund based on a time-based condition.

27. A computer-implemented method for incentivizing logistics hub efficiency in a cooperative network, the method comprising:
receiving, by a processor, a first electronic signal indicating a time of arrival of a package at a local logistics hub;
receiving, by the processor, a second electronic signal indicating a time of pickup of the package from the local logistics hub by a recipient;
calculating, by the processor, a storage duration for the package based on a difference between the time of arrival and the time of pickup;
aggregating, by the processor, storage duration data for a plurality of packages handled by the local logistics hub to generate a performance metric for said hub; and
using, by the processor, said performance metric as a factor in a surplus distribution algorithm to determine a share of an operational surplus to be allocated to an operator of the local logistics hub.

28. The method of claim 27, wherein a lower value of the performance metric, indicating a shorter average storage duration, results in a proportionally larger share of the operational surplus being allocated to the operator of the local logistics hub.

29. The method of claim 27, further comprising:
providing, by the processor to a computing device associated with the operator of the local logistics hub, a user interface enabling the operator to define a rule for a customer-facing incentive, said rule comprising a time window and an associated offer; and
in response to the arrival of a package for a recipient, automatically transmitting, by the processor to a computing device of the recipient, a notification of the offer if the recipient picks up the package within the time window defined in the rule.
